(19) United States
(12) Patent Application Publication
(10) Pub. No.: US 2021/0044054 A1
(43) Pub. Date: Feb. 11, 2021

(54) WATERPROOF CONNECTOR

(71) Applicants: AUTONETWORKS TECHNOLOGIES, LTD., Yokkaichi-shi (JP); SUMITOMO WIRING SYSTEMS, LTD., Yokkaichi-shi (JP); SUMITOMO ELECTRIC INDUSTRIES, LTD., Osaka (JP)

(72) Inventors: Yusaku MAEDA, Yokkaichi-shi (JP); Ryotaro KOSAKA, Yokkaichi-shi (JP)

(73) Assignees: AUTONETWORKS TECHNOLOGIES, LTD., Yokkaichi-shi (JP); SUMITOMO WIRING SYSTEMS, LTD., Yokkaichi-shi (JP); SUMITOMO ELECTRIC INDUSTRIES, LTD., Osaka (JP)

(21) Appl. No.: 16/936,081

(22) Filed: Jul. 22, 2020

(30) Foreign Application Priority Data
Aug. 8, 2019 (JP) 2019-146013

(51) Int. Cl. H01R 13/52; H01R 13/502

(52) U.S. Cl. CPC H01R 13/5216; H01R 13/502; H01R 13/5221

(57) ABSTRACT

A waterproof connector, including: a seal including an insertion hole as a through hole; and a connector terminal configured as a male terminal including a tab to be fit and connected to a mating terminal, wherein: the connector terminal is inserted into the insertion hole of the seal along an insertion axis, and a width of the tab of the connector terminal has a tab width W and an inner diameter of a narrowest part having a smallest inner diameter of a transverse cross-section orthogonal to the insertion axis in the insertion hole has a minimum hole diameter Dm, the minimum hole diameter Dm satisfies 1.1<Dm/W<1.4 in a state where the connector terminal is not inserted in the insertion hole.

### BACKGROUND

The present disclosure relates to a waterproof connector.

A waterproof connector with a seal member to suppress the intrusion of water into the connector may be used as a connector used in connecting an electrical component inside a vehicle such as an automotive vehicle. The seal member is configured as a molded body of rubber or the like and includes an insertion hole through which a connector terminal is insertable. By inserting a wire with terminal, in which a connector terminal is connected to an end of a wire, into the insertion hole of the seal member accommodated in a connector housing, a waterproof connector is configured. Waterproof connectors and seal members of that type are disclosed in Japanese Unexamined Patent Publication No. 2018-159020 Japanese Unexamined Patent Publication No. 2016-58138

### SUMMARY

In the case of forming the waterproof connector by inserting the wire with terminal into the insertion hole of the seal member, the connector terminal constituting the wire with terminal normally exhibits waterproofness by passing through the insertion hole and having the surface of the wire held in close contact with an inner wall surface of the insertion hole. To ensure waterproofness, the wire having an outer diameter larger than an inner diameter of the insertion hole at a narrowest location is used. In many cases, a cross-sectional dimension of a connector terminal to be connected to a wire is larger than that of the wire and an inner wall surface of an insertion hole may be dragged by the connector terminal and the seal member may be torn when a part of the connector terminal of a wire with terminal passes in the insertion hole. The tear of the seal member damages the waterproofness of the waterproof connector.

In Japanese Unexamined Patent Publication No. 2018-159020, the tear of a seal member is suppressed by making the seal member of thermosetting silicone rubber containing three units respectively having predetermined chemical structures in molecules. Also in Japanese Unexamined Patent Publication No. 2016-58138, the scratch of a seal member is reduced by constituting the seal member of a material obtained by mixing polyrotaxane with silicone rubber. By studying the material of the seal member in this way, the tear of the seal member can be suppressed, but not only the material of the seal member, but also the structure of the seal member, particularly the shape and dimensions of the insertion hole should largely affect whether or not the seal member is torn. In Japanese Unexamined Patent Publication No. 2018-159020 Japanese Unexamined Patent Publication No. 2016-58138, the constituent material of the seal member is focused and the shape and dimensions of the insertion hole are not described in detail.

An exemplary aspect of the disclosure provides a waterproof connector including an insertion hole shaped such that waterproofness is less likely to be reduced by the tear of a seal member when a connector terminal is inserted into the insertion hole of the seal member.

The present disclosure is directed to a waterproof connector with a seal including an insertion hole as a through hole, and a connector terminal configured as a male terminal including a tab to be fit and connected to a mating terminal, wherein the connector terminal is inserted into the insertion hole of the seal along an insertion axis and, a width of the tab portion of the connector terminal has a tab width W and an inner diameter of a narrowest part having a smallest inner diameter of a transverse cross-section orthogonal to the insertion axis in the insertion hole has a minimum hole diameter Dm, the minimum hole diameter Dm satisfies 1.1<Dm/W<1.4 in a state where the connector terminal is not inserted in the insertion hole.

The waterproof connector according to the present disclosure includes the insertion hole shaped such that waterproofness is less likely to be reduced by the tear of the seal when the connector terminal is inserted into the insertion hole of the seal.

### BRIEF DESCRIPTION OF THE DRAWINGS

FIG. 1 is an exploded perspective view showing the configuration of a waterproof connector according to an embodiment of the present disclosure,

FIG. 2 is a plan view showing a seal member provided in the waterproof connector, and

FIG. 3A is an enlarged section of the seal member cut along an insertion axis A and FIG. 3B is an enlarged plan view of the seal member viewed from a direction along the insertion axis A.

### DETAILED DESCRIPTION OF EMBODIMENTS

### Description of Embodiments of Present Disclosure

First, embodiments of the present disclosure are listed and described.

The waterproof connector according to the present disclosure is provided with a seal member including an insertion hole as a through hole, and a connector terminal configured as a male terminal including a tab portion to be fit and connected to a mating terminal, wherein the connector terminal is inserted into the insertion hole of the seal member along an insertion axis and, if a width of the tab portion of the connector terminal is a tab width W and an inner diameter of a narrowest part having a smallest inner diameter of a transverse cross-section orthogonal to the insertion axis in the insertion hole is a minimum hole diameter Dm, the minimum hole diameter Dm satisfies 1.1<Dm/W<1.4 in a state where the connector terminal is not inserted in the insertion hole.

In the above waterproof connector, the tab width W of the connector terminal configured as a male connector terminal and the minimum hole diameter Dm in the insertion hole of the seal member satisfy Dm/W>1.1. By specifying these parameters such that the minimum hole diameter Dm does not become excessively smaller than the tab width W in this way, a contact area between the inner wall surface of the insertion hole and the connector terminal and a load applied to the inner wall surface of the insertion hole from the connector terminal can be suppressed to be small when the connector terminal is inserted into the insertion hole of the seal member. As a result, the inner wall surface of the insertion hole is less likely to be dragged by the connector terminal while the connector terminal is passing in the insertion hole, and the occurrence of a tear caused by dragging can be suppressed. Thus, in the manufactured waterproof connector, a reduction in waterproofness due to the tear of the seal member is easily avoided.

On the other hand, by setting Dm/W<1.4 and preventing the minimum hole diameter Dm from becoming excessively larger than the tab width W, the close contact of the inner wall surface of the insertion hole of the seal member with the connector terminal and the wire connected to the connector terminal can be ensured and high waterproofness can be exhibited by the seal member. By setting Dm/W in the predetermined range in the above waterproof connector as just described, high waterproofness can be achieved by both the suppression of the tear of the seal member and the ensuring of the close contact of the seal member.

Here, a lip portion shaped to be convex inwardly of the insertion hole in a longitudinal cross-section parallel to the insertion axis may be formed on an inner wall surface of the insertion hole and a top part of the lip portion may serve as the narrowest part, and if an angle formed by two tangents to slopes on both sides of the top part of the lip portion in the longitudinal cross-section is a lip angle θ1, the lip angle θ1 may be smaller than 90° in the state where the connector terminal is not inserted in the insertion hole. By setting 01<90° and preventing the lip angle θ1 from becoming excessively large, the lip portion is easily tilted along the insertion axis when the connector terminal passes in the insertion hole. By the tilt of the lip portion, a load is less likely to be concentrated in a region where the top part of the lip portion is narrow. This can suppress damage in the lip portion and a reduction in the waterproofness of the waterproof connector when the connector terminal passes.

The seal member may include a plurality of the insertion holes and the insertion holes may be arranged in a plurality of rows along a horizontal direction and in fewer rows in a vertical direction intersecting the horizontal direction than in the horizontal direction in a surface of the seal member, and if a thickness of the seal member between an end edge of an opening part of the outermost insertion hole along the vertical direction and an end edge of the seal member located outside the insertion hole along the vertical direction is a vertical excess length T1, the vertical excess length T1 may satisfy T1/Dm>2.1 in the state where the connector terminal is not inserted in the insertion hole. By ensuring a sufficient dimension outside the insertion hole as the vertical excess length T1 in the seal member, the insertion hole is less likely to be deformed along the vertical direction even if a force in the vertical direction is applied to the seal member, such as when the seal member is accommodated into the connector housing. As a result, a reduction in waterproofness due to the deformation of the insertion hole can be suppressed.

The seal member may include a plurality of the insertion holes and the insertion holes may be arranged in a plurality of rows along a horizontal direction and in fewer rows in a vertical direction intersecting the horizontal direction than in the horizontal direction in a surface of the seal member, and if a thickness of the seal member between an end edge of an opening part of the outermost insertion hole along the horizontal direction and an end edge of the seal member located outside the insertion hole along the horizontal direction is a horizontal excess length T2, the horizontal excess length T2 may satisfy T2/Dm>1.1 in the state where the connector terminal is not inserted in the insertion hole. By ensuring a sufficient dimension outside the insertion hole as the horizontal excess length T2 in the seal member, the insertion hole is less likely to be deformed along the horizontal direction even if a force in the horizontal direction is applied to the seal member, such as when the seal member is accommodated into the connector housing. As a result, a reduction in waterproofness due to the deformation of the insertion hole can be suppressed.

The waterproof connector may further include a connector housing having a hollow part and the seal member may be accommodated in a compressed state in the hollow part of the connector housing, the seal member may include a plurality of the insertion holes and the insertion holes may be arranged in a plurality of rows along a horizontal direction and in fewer rows in a vertical direction intersecting the horizontal direction than in the horizontal direction in a surface of the seal member, and if a dimension along the vertical direction is a seal vertical dimension L1 and a dimension along the horizontal direction is a seal horizontal dimension L2 in the seal member in a state not accommodated in the connector housing, an inner dimension of the hollow part along the vertical direction of the seal member is a housing vertical dimension L′1 and an inner dimension of the hollow part along the horizontal direction of the seal member is a housing horizontal dimension L′2 in the hollow part of the connector housing, and a vertical compression rate R1 and a horizontal compression rate R2 of the seal member are L1/L′1 and L2/L′2, the vertical and horizontal compression rates R1, R2 may satisfy a relationship of 0.9<R2/R1<1.1. By preventing the horizontal and vertical compression rates from largely differing from each other when the seal member is accommodated into the connector housing while being compressed in this way, a reduction in waterproofness due to the insertion hole compressed into a distorted shape to change a ratio of a vertical dimension to a horizontal dimension of the cross-sectional shape is easily suppressed.

At least two lip portions shaped to be convex inwardly of the insertion hole in a longitudinal cross-section parallel to the insertion axis may be formed along the insertion axis on an inner wall surface of the insertion hole, and if an inner diameter of a lip valley having a largest inner diameter of the transverse cross-section orthogonal to the insertion axis between two lip portions adjacent along the insertion axis is a valley hole diameter Dv, the valley hole diameter Dv may satisfy Dv/W>2.3 in the state where the connector terminal is not inserted in the insertion hole. Then, since the valley having a sufficiently large inner diameter is formed between the two lip portions, the lip portion is easily tilted toward the valley and the lip portions are less likely to be dragged by the connector terminal when the connector terminal passes in the insertion hole. As a result, the tear of the inner wall surface of the insertion hole due to the drag of the lip portions can be suppressed and high waterproofness is easily ensured in the waterproof connector.

The valley hole diameter Dv may satisfy Dv/W<2.7 in the state where the connector terminal is not inserted in the insertion hole. Then, close contact between the inner wall surface of the insertion hole and the connector terminal or the wire connected to the connector terminal is easily ensured and the waterproofness of the waterproof connector is easily enhanced by avoiding a situation where it is difficult to obtain a sufficiently large contact area between the inner wall surface of the insertion hole and the connector terminal or the wire connected to the connector terminal due to the lip valley having an excessively large inner diameter.

The insertion hole may include an enlarged diameter portion enlarged in diameter from an inner side toward an outer side along the insertion axis on an end part along the insertion axis and, if a maximum value of an inner diameter of the enlarged diameter portion is an opening hole diameter Do, the opening hole diameter may satisfy Do/W>3.5 in the state where the connector terminal is not inserted in the insertion hole. By ensuring a large opening hole diameter Do in the enlarged diameter portion of the insertion hole, the connector terminal is easily guided by the enlarged diameter portion and the connector terminal easily moves straight with respect to the insertion axis of the insertion hole when the connector terminal is inserted into the insertion hole. Then, a large load is less likely to be applied to the inner wall surface of the insertion hole from the connector terminal passing in the insertion hole, and a reduction in waterproofness due to the damage of the inner wall surface is easily suppressed.

The seal member may contain silicone rubber. Then, the tear of the seal member during the insertion of the connector terminal is effectively suppressed and high waterproofness is easily obtained by the resilience of the silicone rubber.

A hardness of the seal member may be 10 or more and 30 or less in Shore A hardness. Then, the seal member has a suitable strength and a state where a constituent material of the seal member is held in close contact with the connector terminal and the wire connected to the connector terminal on the inner wall surface of the insertion hole is easily maintained, and high waterproofness is easily ensured. Simultaneously, a suitable flexibility is ensured in the seal member and the occurrence of a tear can be effectively suppressed when the connector terminal is inserted into the insertion hole.

The connector terminal may be connected to an end of a wire, and the inner wall surface of the insertion hole of the seal member may be in contact with a surface of the wire. When the connector terminal connected to the end of the wire is inserted into the insertion hole of the seal member and passes through the insertion hole, the tear of the seal member is suppressed, whereby the surface of the wire can be held in close contact with the inner wall surface of the untorn insertion hole. As a result, high waterproofness is ensured between the seal member and the wire.

### Details of Embodiment of Present Disclosure

Hereinafter, a waterproof connector according to one embodiment of the present disclosure is described in detail using the drawings. The waterproof connector according to the one embodiment of the present disclosure includes a seal member having insertion holes and connector terminals, the connector terminals are inserted into the insertion holes, and a tab width of the connector terminal and an inner diameter of a narrowest part of the insertion hole of the seal member have a predetermined relationship.

In this specification, an essential figure of each numerical value indicating a ratio defined by a relationship of dimensions of constituent members and dimensions of a plurality of parts is specified by a number of digits as described. Further, each ratio defined by the relationship of the dimensions of the constituent members and the dimensions of the plurality of parts is specified for a state where the connector terminal or a wire is not inserted in the insertion hole of the seal member and the seal member is not inserted in a connector housing. Further, in this specification, concepts representing the shapes and arrangements of members such as parallel, perpendicular, orthogonal, rectangular, circular and elliptical include not only geometrically strict concepts, but also deviation ranges of a permissible extent as the connector and constituent members of the connector.

<Summary of Structure of Waterproof Connector>

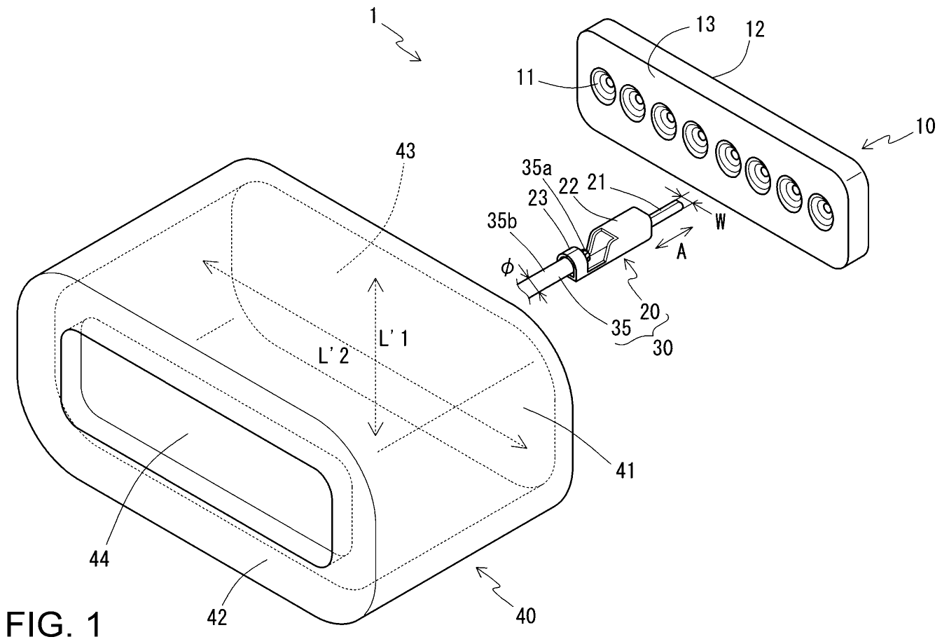

First, a summary of the structure of the waterproof connector according to the embodiment of the present disclosure is described. A waterproof connector 1 according to one embodiment of the present disclosure is shown in an exploded perspective view in FIG. 1.

The waterproof connector 1 includes a seal member 10 (seal) and connector terminals (hereinafter, merely referred to as “terminals” in some cases) 20. The connector terminal 20 is provided in the form of a wire with terminal 30 by being connected to an end of a wire 35 in the waterproof connector 1. The waterproof connector 1 further includes a connector housing 40 (hereinafter, merely referred to as a “housing” in some cases).

Although described in detail later, the seal member 10 is configured as a plate-like body and includes insertion holes 11 into which the terminals 20 are insertable. The seal member 10 may be provided with one insertion hole 11 or a plurality of insertion holes 11, but the seal member 10 formed such that a plurality of the insertion holes 10 are arranged in a horizontal direction in a plate surface of the seal member 10 is described here. Note that the seal member 10 may be formed with a plurality of insertion holes 11 also in a vertical direction intersecting the horizontal direction. The outer shape of the seal member 10 is also not particularly limited, but the seal member 10 is shown as a rectangular plate-like body with rounded corners here.

The terminal 20 is inserted into each of the plurality of insertion holes 11 of the seal member 10. Although the terminals 20 are respectively inserted into all the plurality of insertion holes 11 formed in the seal member 10, only one terminal 20 is shown for simplification in FIG. 1.

In the waterproof connector 1, the terminal 20 inserted into the insertion hole 11 of the seal member 10 is in the form of the wire with terminal 30 by being connected to the end of the wire 35. The terminal 20 integrally includes a tab portion 21 (tab), a tubular portion 22 and a crimping portion 23 continuously in a longitudinal direction from a tip side. The tab portion 21 is a part to be electrically connected to a mating terminal (not shown). In this embodiment, the terminal 20 is configured as a male terminal of a fitting type. That is, the tab portion 21 is configured as a flat plate-like tab-shaped part and can be fit and connected to a mating female terminal. The tubular portion 22 is a part coupling the tab portion 21 and the crimping portion 23 and in the form of a rectangular tube in a shown example. The crimping portion 23 is a part to be crimped and fixed to the wire 35. The wire 35 includes a conductor 35a and an insulation coating 35b covering the outer periphery of the conductor 35a. The insulation coating 35b is removed to expose the conductor 35a at an end part of the wire 35 and the crimping portion 23 of the terminal 20 is crimped and fixed to the exposed conductor 35a.

A size of the terminal 20 is determined by a tab width W, i.e. a width of the tab portion 21. The tab width W is not particularly limited, but can be illustrated to be 0.5 mm or more and 1.5 mm or less. In a male terminal generally used in the field of automobiles, dimensions of each part and an outer diameter ϕ of the wire 35 applied are determined within substantially fixed ranges according to the tab width W. Typically, a width of the tubular portion 22, which is a part of the terminal 20 having a largest width, is set in a range of 1.2-fold or more and 2.8-fold or less of the tab width W. Further, the outer diameter ϕ of the wire 35 to be connected to the terminal 20 is set in a range of 1.8-fold or more and 3.2-fold or less of the tab width W.

The wire with terminal 30 is inserted into the insertion hole 11 from the side of a rear surface 13 to the side of a front surface 12 of the seal member 10 along an insertion axis A parallel to a thickness direction of the seal member 10. The wire with terminal 30 is so inserted that the terminal 20 is entirely passed through the insertion hole 11 in the longitudinal direction. That is, in the waterproof connector 1, the wire with terminal 30 is disposed such that a part of the wire 35 connected to the terminal 20 is arranged in the insertion hole 11 and the outer peripheral surface of the wire 35 is surrounded by an inner wall surface of the insertion hole 11.

In the waterproof connector 1, the seal member 10 is accommodated in the housing 40. The housing 40 is made of a material harder than the seal member 10 and integrally has a side wall surface 41 in the form of a rectangular tube and a rear wall surface 42 provided on one end of the side wall surface 41. No wall surface is provided on the other end of the side wall surface 41, which serves as an opening 43. The rear wall surface 42 is preferably shaped to be smaller than the plate surface of the seal member 10. Further, a window portion 44 is provided as a region not closed by a constituent material of the housing 40 in the rear wall surface 42. The position and size of the window portion 44 are so set that all the insertion holes 11 are accommodated in the window portion 44 when the seal member 10 is accommodated into the housing 40 and held in close contact with the rear wall surface 42.

In the waterproof connector 1, the seal member 10 is accommodated into the housing 40 through the opening 43 and the rear surface 13 of the seal member 10 is brought into contact with the rear wall surface 42 of the housing 40. Since the rear wall surface 42 of the housing 40 is formed to be smaller than the outer shape of the seal member 10, the seal member 10 is accommodated 40 while being compressed. A group of the insertion holes 11 provided in the seal member 10 face an outside space via the window portion 44 of the housing 40.

Further, the wire with terminal 30 is inserted into each insertion hole 11 of the seal member 10 accommodated in the housing 40. At this time, the terminal 20 constituting the wire with terminal 30 is inserted into the insertion hole 11 from the rear surface 13 of the seal member 10 via the window portion 44. The terminal 20 passes through the insertion hole 11 and the wire 35 is arranged in the insertion hole 11 as described above. Although not shown, the waterproof connector 1 further includes an inner housing arranged inside the housing 40 and including terminal accommodation chambers for accommodating the terminals 20, and the terminal 20 passed through the insertion hole 11 of the seal member 10 is accommodated into the terminal accommodation chamber of the inner housing. The waterproof connector 1 is connected to a mating connector (not shown) in the opening 43 of the housing 40 and the tab portions 21 of the terminals 20 accommodated in the housing 40 are fit to mating terminals.

In the waterproof connector 1, the seal member 10 functions to suppress the intrusion of water (or another liquid; the same shall apply hereinafter) from outside into a space surrounded by the housing 40. Specifically, the inner wall surface of the insertion hole 11 of the seal member 10 is held in close contact with the outer peripheral surface of the wire 35 inserted in the form of the wire with terminal 30, whereby the intrusion of water into the housing 40 from around the wire with terminal 30 can be suppressed. In addition, the rear surface 13 of the seal member 10 is held in close contact with the rear wall surface 42 of the housing 40, whereby the intrusion of water from outside the wall surface of the housing 40, particularly the intrusion of water from the window portion 44 of the rear wall surface 42, can be suppressed. As described in detail later, the suppression of water intrusion into the housing 40 is effectively achieved by specifying dimensions of each part of the insertion hole 11, further by specifying dimensions of the entire seal member 10 by the housing 40.

<Seal Member>

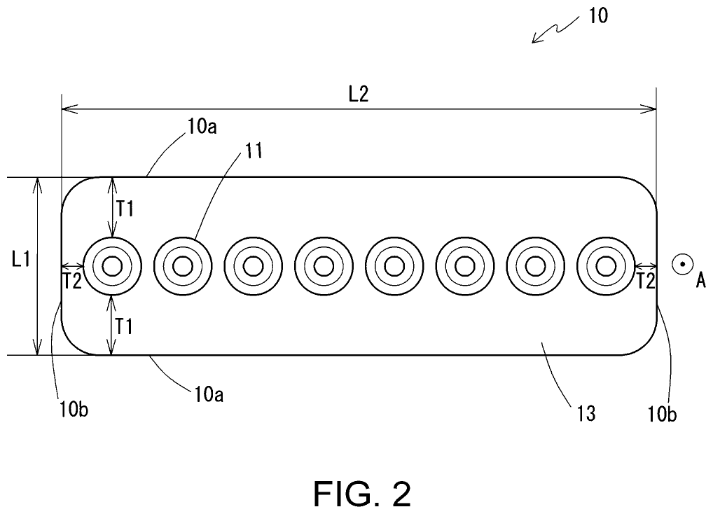

Next, the seal member 10 constituting the above waterproof connector 1 is described. The overall shape of the seal member 10 is shown in FIGS. 1 and 2. As described above, the seal member 10 is configured as the plate-like body having the front and rear surfaces 12, 13 parallel to each other, and includes the insertion holes 11 penetrating between the front and rear surfaces 12, 13 along the insertion axis A parallel to the thickness direction.

(Constituent Material of Seal Member)

A material constituting the seal member 10 is not particularly limited if the material can block the permeation of water. Typically, the seal member 10 contains an organic polymer, preferably mainly contains the organic polymer, i.e. contains 50 mass % or more of the organic polymer in the entire seal member 10. The organic polymer may preferably contain at least either rubber or elastomer. Then, the seal member 10 is held in close contact with the housing 40, the inner wall surface of the insertion hole 11 is held in close contact with the outer peripheral surface of the wire with terminal 30 and high waterproofness is easily exhibited in the waterproof connector 1 due to the resilience of rubber and elastomer. Further, even when a mechanical load such as vibration is applied to the waterproof connector 1, a state held in close contact with each wire with terminal 30 and the housing 40 is maintained and a state where high waterproofness is provided is easily kept.

The use of the silicone rubber as the organic polymer material constituting the seal member 10 is particularly preferable. The silicone rubber exhibits high waterproofness and resilience and is, in addition, excellent in mechanical strength, thermal stability and chemical stability. Addition reaction type silicone rubber having a thermosetting property is preferably used as the silicone rubber. The addition reaction type silicone rubber contains alkenyl group-containing organopolysiloxane as a main component and hydroxyl group-containing organopolysiloxane as a curing agent, and molecular chains of those are cross-linked by a platinum catalyst. Examples of the alkenyl group include a vinyl group, an aryl group, a butenyl group and a pentenyl group. The organopolysiloxane includes a polysiloxane chain (—Si—O—Si—O—) as a main chain and organic groups on Si atoms of the main chain. Examples of organic groups of the organopolysiloxane include methyl groups, ethyl groups and phenyl groups. For example, silicon rubber similar to the one described in Japanese Unexamined Patent Publication No. 2018-159020 can be suitably used. The silicone rubber may contain an additive and a filler as appropriate.

A hardness of the constituent material of the seal member 10 is preferably 30 or less in Shore A hardness. If the Shore A hardness is 30 or less, the flexibility of the seal member 10 is ensured and the seal member 10 is more easily held in close contact with the housing 40 and each wire with terminal 30. When the terminal 20 is inserted into the insertion hole 11, the tear of the seal member 10 is less likely to occur due to the flexibility of the seal member 10. Thus, the seal member 10 easily exhibits high waterproofness. On the other hand, the hardness of the constituent material of the seal member 10 is preferably 10 or more in Shore A hardness. If the Shore A hardness is 10 or more, a suitable strength is ensured in the seal member 10 and a state where the seal member 10 is held in close contact with the wires 35 and the housing 40 is easily maintained, wherefore high waterproofness is more easily ensured. Here, the Shore A hardness is a value at room temperature and can be measured in accordance with JIS K 6253. Further, if a polymer material constituting the seal member 10 is curable like the above addition reaction type silicone rubber, the Shore A hardness of the entire seal member 10 is evaluated in a state after curing.

A modulus of elasticity of the constituent material of the seal member 10 is preferably 0.2 MPa or more and 0.6 MPa or less at a tensile stress value when 100% modulus, i.e. elongation of 100% is given. If the constituent material of the seal member 10 has a modulus of elasticity of 0.2 MPa or more, the tear of the inner wall surface of the insertion hole 11 is more easily avoided by the softness of the material when the terminal 20 is inserted into the insertion hole 11. On the other hand, if the constituent material of the seal member 10 has a modulus of elasticity of 0.6 MPa or less, the seal member 10 is more easily resiliently held in close contact with the housing 40 and each wire with terminal 30. Here, the modulus of elasticity is a value at room temperature and can be measured in accordance with JIS K7161.

(Structure of Insertion Hole)

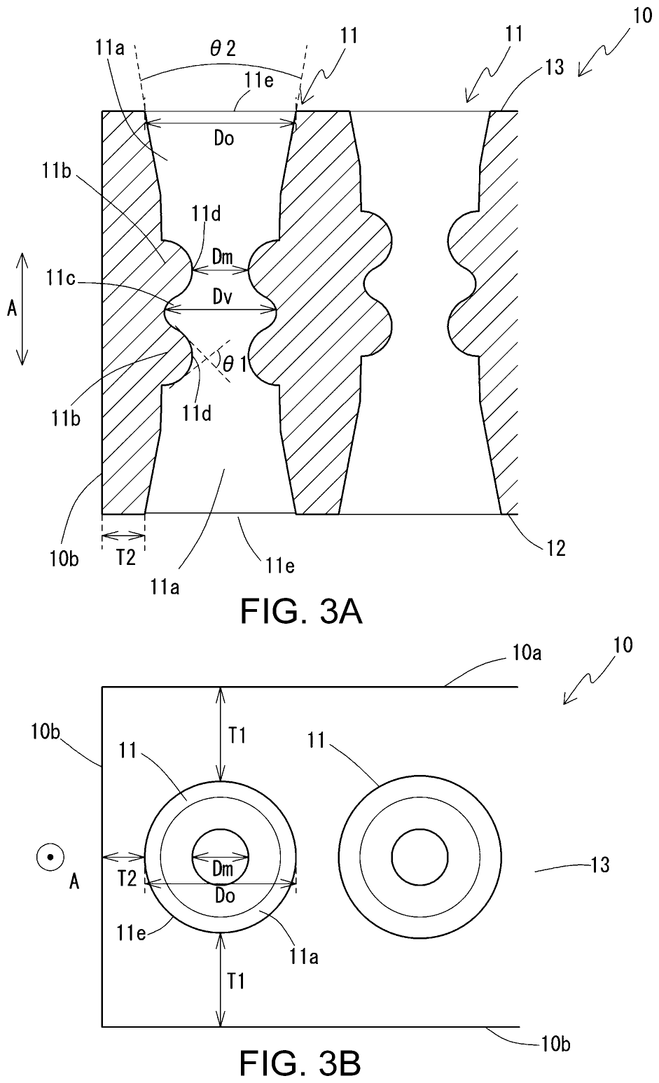

The insertion hole 11 penetrates between the front and rear surfaces 12, 13 of the seal member 10 along the insertion axis A. As a longitudinal cross-section (cross-section parallel to the insertion axis A) of the insertion hole 11 is shown in FIG. 3A, the insertion hole 11 is not formed into a straight tube shape having a flat inner wall surface, but has an uneven structure on the inner wall surface and an inner diameter of the insertion hole 11 changes at each position along the insertion axis A. Specifically, the insertion hole 11 includes enlarged diameter portions 11a gradually enlarged in diameter from an inner side toward an outer side along the insertion axis A at positions of end parts facing the front and rear surfaces 12, 13. Further, the insertion hole 11 includes lip portions 11b in an intermediate part along the insertion axis A. The lip portion 11b is formed to have an inwardly convex shape by a ring-like part of the constituent material of the seal member 10 projecting radially inwardly of the insertion hole 11, and the inner diameter of the insertion hole 11 is reduced at a position where the lip portion 11b is formed. The number of the lip portions 11b is not particularly limited, but at least two lip portions 11b are preferably provided along the insertion axis A as shown. In this case, a part between two adjacent lip portions 11b and having a larger inner diameter serves as a lip valley 11c.

Here, the inner diameter of the insertion hole 11 indicates a diameter when the cross-section (transverse cross-section) of the insertion hole 11 cut orthogonal to the insertion axis A is approximated to a circle at each position along the insertion axis A. If the transverse cross-sectional shape of the insertion hole 11 is not circular, a length of a shortest straight line passing through a center of gravity of the cross-sectional shape and crossing the cross-section may be set as the inner diameter of the insertion hole 11. If the cross-sectional shape can be approximated to an ellipse, a length of a minor axis of that ellipse is set as the inner diameter of the insertion hole 11. As described above, in the insertion hole 11, the inner diameter of the insertion hole 11 changes at each position along the insertion axis A. The cross-sectional shape of the insertion hole 11 at each position along the insertion axis A may be any shape, but is preferably circular or elliptical, particularly preferably circular from the perspective of structural simplicity and the like.

In the seal member 10 constituting the waterproof connector 1 according to this embodiment, the cross-sectional dimension and angle of each part of the insertion hole 11 are specified to suppress the occurrence of the tear of the inner wall surface of the insertion hole 11 when the terminal 20 is inserted into and passed through the insertion hole 11 and to hold the inner wall surface of the insertion hole 11 in close contact with the surface of the wire 35 with the terminal 20 passed through the insertion hole 11 and a part of the wire 35 of the wire with terminal 30 arranged in the insertion hole 11. If the inner wall surface of the insertion hole 11 is torn, a clearance is possibly formed between the inner wall surface of the insertion hole 11 and the wire 35 arranged in the insertion hole 11 at a torn location. Further, the torn location possibly becomes a water intrusion path. If those phenomena occur, it becomes difficult to maintain sufficient waterproofness between the inner wall surface of the insertion hole 11 and the wire with terminal 30 in the seal member 10. However, by suppressing the occurrence of the tear, those phenomena can be avoided and high waterproofness can be ensured in the waterproof connector 1. Further, unless the inner wall surface of the insertion hole 11 can be held in close contact with the outer peripheral surface of the wire 35, a clearance is easily formed between the inner wall surface of the insertion hole 11 and the wire 35. Such a clearance possibly becomes a water intrusion path and causes a reduction in the waterproofness of the seal member 10. However, by enabling the inner wall surface of the insertion hole 11 to be held in close contact with the outer peripheral surface of the wire 35, the intrusion of water into the housing 40 from between the insertion hole 11 and the wire 35 can be suppressed. By specifying the cross-sectional dimension and angle of each part of the insertion hole 11 as described below, it is possible to suppress the tear of the inner wall surface of the insertion hole 11 and improve waterproofness by ensuring close contact with the wire with terminal 30.

Specifically, with the inner diameter of the narrowest part of the insertion hole 11 set as a minimum hole diameter Dm, that minimum hole diameter Dm satisfies 1.1<Dm/W<1.4 in a relationship with the tab width W of the terminal 20. Here, the narrowest part of the insertion hole 11 indicates a part having a smallest inner diameter of the transverse cross-section along the insertion axis A of the insertion hole 11. In the shown form, the positions of top parts 11d of the lip portions 11b at two positions are narrowest parts.

If the minimum hole diameter Dm satisfies Dm/W>1.1, the minimum hole diameter Dm does not become excessively small with respect to the size of the terminal 20 to be inserted in the insertion hole 11. If an attempt is made to insert a terminal 20 of a large size into the insertion hole 11 having a small minimum hole diameter Dm, a mechanical load is applied from the terminal 20 to the inner wall surface of the insertion hole 11 including the narrowest parts during insertion, and the constituent material of the seal member 10 is possibly torn on the inner wall surface of the insertion hole 11. Particularly, if the narrowest parts are provided as the top parts 11d of the lip portions 11b, the lip portions 11b are dragged by the terminal 20 and the inner wall surface of the insertion hole 11 is easily torn when the terminal 20 moves in the insertion hole 11. As described above, if the inner wall surface of the insertion hole 11 is torn, a clearance is formed between the inner wall surface and the wire with terminal 30 at a torn location and a water intrusion path is formed, whereby the waterproofness of the waterproof connector 1 is reduced.

However, by setting Dm/W>1.1 as also shown in Examples later, the minimum hole diameter Dm can be set to be sufficiently larger than the size of the terminal 20 to be inserted into the insertion hole 11. By setting the minimum hole diameter Dm large in that way, a contact area between the terminal 20 and the inner wall surface of the insertion hole 11 can be reduced and a load applied to the inner wall surface of the insertion hole 11 can be suppressed to be low when the terminal 20 passes in the insertion hole 11. Then, when the terminal 20 is inserted into the insertion hole 11, the inner wall surface of the insertion hole 11, particularly the lip portions 11b, is less likely to be dragged by the terminal 20 and the constituent material of the seal member 10 is less likely to be torn. As a result, in a state where the terminal 20 is passed through the insertion hole 11 and the wire 35 constituting the wire with terminal 30 is arranged in the insertion hole 11, the untorn inner wall surface of the insertion hole 11 is in contact with the outer peripheral surface of the wire 35 and a clearance is less likely to be formed between the inner wall surface of the insertion hole 11 and the surface of the wire 35. Due to the absence of such a clearance, a tear, which will become a water intrusion path, is not formed in the inner wall surface of the insertion hole 11. Thus, high waterproofness is exhibited in the waterproof connector 1. If Dm/W 1.2, the tear of the seal member 10 is more easily avoided.

On the other hand, if the minimum hole diameter Dm satisfies Dm/W<1.4, the insertion hole 11 can be kept suitably smaller than the wire with terminal 30. As the terminal 20 has a smaller tab width W in the wire with terminal 30, a wire having a smaller outer diameter ϕ is connected as the wire 35 compatible with the terminal 20. If the inner diameter of the insertion hole 11 is excessively larger than the outer diameter ϕ of the wire 35 to be arranged in the insertion hole 11, the inner wall surface of the insertion hole 11 cannot be held in close contact with the outer peripheral surface of the wire 35. Then, a clearance is easily formed between the inner wall surface of the insertion hole 11 and the wire 35. Such a clearance possibly becomes a water intrusion path and causes a reduction in the waterproofness of the seal member 10. However, by setting Dm/W<1.4 as also shown in Examples later, the intrusion of water into the housing 40 can be highly suppressed by the close contact of the inner wall surface of the insertion hole 11 with the outer peripheral surface of the wire 35 in the state where the terminal 20 is passed through the insertion hole 11 and the wire 35 constituting the wire with terminal 30 is arranged in the insertion hole 11. Particularly, if the waterproof connector 1 is placed in a high-temperature environment, the waterproofness of the waterproof connector 1 is possibly reduced due to a thermal effect such as denaturation on the constituent material of the seal member 10. However, by setting Dm/W<1.4, the insertion hole 11 and the wire 35 are maintained in close contact and high waterproofness is easily kept even if the connector 1 is placed in a high-temperature environment.

If Dm/W≤1.3, close contact between the insertion hole 11 and the wire with terminal 30 is more easily enhanced. Further, from the perspective of more easily ensuring close contact between the insertion hole 11 and the wire 35, the minimum hole diameter Dm preferably satisfies Dm/ϕ<0.51, more preferably satisfies Dm/ϕ≤0.50 in a relationship with the outer diameter (diameter of the outer periphery) ϕ of the wire 35. Note that even if the waterproof connector is configured such that not the wire 35, but the terminal 20 itself is arranged in the insertion hole 11 without the terminal 20 being entirely passed through the insertion hole 11 in the longitudinal direction when the wire with terminal 30 is inserted into the insertion hole 11, the intrusion of water from between the terminal 20 and the insertion hole 11 can be suppressed and the waterproofness of the waterproof connector can be enhanced by setting Dm/W>1.1.

As just described, by setting the minimum hole diameter Dm of the insertion hole 11 within the range of 1.1<Dm/W<1.4 in the seal member 10, the waterproof connector 1 can have high waterproofness by suppressing both a reduction in waterproofness due to the tear of the seal member 10 when the terminal 20 is inserted into the insertion hole 11 and a reduction in waterproofness due to insufficiently close contact between the inner wall surface of the insertion hole 11 and the wire with terminal 30. Particularly, in the case where many insertion holes 11 are provided in the single seal member 10 and the terminal 20 is inserted into each of the insertion holes 11, if waterproof performance is reduced due to the tear of the seal member 10 or insufficiently close contact with the wire with terminal 30 in some insertion holes 11 out of the many insertion holes 11, that possibly affects the entire seal member 10. Further, in recent years, terminals have been miniaturized as many terminals are integrated. With the integration and miniaturization of terminals, the insertion holes 11 provided in the seal member 10 are also reduced in diameter. However, unless the insertion holes 11 are properly reduced in diameter, sufficient waterproofness may not be obtained due to the tear of the seal member 10 and insufficiently close contact with the terminals 20. Accordingly, by setting the minimum hole diameter Dm to satisfy 1.1<Dm/W<1.4, the seal member 10 can be designed to meet requests of the integration and narrowing of the terminals 20 while maintaining high waterproofness in each insertion hole 11, whereby a contribution can be made to the space saving of the waterproof connector 1.

Note that, in the case of providing many insertion holes 11 in the seal member 10, the diameters of the insertion holes 11 may be made different from each other to deal with the insertion of terminals 20 having different tab widths W into those insertion holes 11. Also in that case, the minimum hole diameter Dm of each insertion hole 11 may be determined as described above in the relationship with the tab width W of the terminal 20 to be inserted into the insertion hole 11. Dimensions of each part other than the minimum hole diameter Dm specifying the insertion hole 11 such as a valley hole diameter Dv and an opening hole diameter Do to be described below may be also similarly determined in the relationship with the tab width W of the terminal 20 to be inserted into the insertion hole 11.

In the insertion hole 11 of the seal member 10, a lip angle θ1 of the lip portions 11b is preferably set to be 01<90°. The lip angle θ1 indicates an angle formed by two tangents to slopes on both sides of the top part 11d of the lip portion 11b in the longitudinal cross-section of the insertion hole 11. If the lip portions 11b can be flexibly tilted along the insertion axis A when the terminal 20 passes in the insertion hole 11, the lip portions 11b are less likely to be dragged by the terminal 20. If the lip angle θ1 is too large, the lip portions 11b are less likely to be tilted. However, by setting the lip angle θ1 small such as θ1<90° and causing a chevron shape of the lip portions 11b to steeply rise, the lip portions 11b are easily flexibly tilted along the insertion axis A and less likely to be dragged by the terminal 20 moving along the insertion axis A in the insertion hole 11. As a result, the tear of the constituent material of the seal member 10 caused by the drag of the lip portions 11b is less likely to occur. From the perspective of further enhancing that effect, the lip angle θ1 is preferably θ1≤75°, more preferably θ1≤70° and even more preferably θ1≤60°. A lower limit of the lip angle θ1 is not particularly determined, but θ1≥30° is preferable from the perspective of ensuring the mechanical strength of the lip portions 11b and the like.

Further, an effect of suppressing the drag due to the tilt of the lip portions 11b increases as a space into which the lip portions 11b can be tilted is formed with a larger margin in the insertion hole 11. From that perspective, a wide space is preferably secured between the adjacent lip portions 11b. That is, the valley hole diameter Dv specified as an inner diameter of the lip valley 11c, which is a part having a largest inner diameter between the two lip portions 11b adjacent along the insertion axis A, is preferably large. Specifically, the valley hole diameter Dv may satisfy Dv/W>2.3 in a relationship with the tab width W of the terminal 20. Then, when the terminal 20 passes in the insertion hole 11, the lip portion 11b is more easily tilted toward the lip valley 11c and less likely to be dragged by the terminal 20. From the perspective of further enhancing that effect, Dv/W 2.4 is more preferable.

On the other hand, even if the valley hole diameter Dv is too large, the contact area between the inner wall surface of the insertion hole 11 and the outer peripheral surface of the wire 35 is possibly reduced with the wire 35 of the wire with terminal 30 arranged in the insertion hole 11. Accordingly, if Dv/W<2.7 is set, a large contact area between the inner wall surface of the insertion hole 11 and the outer peripheral surface of the wire 35 is easily secured. As a result, the inner wall surface of the insertion hole 11 is held in closer contact with the wire 35, which is effective in improving waterproofness. From the perspective of further enhancing that effect, Dv/W≤2.6 is more preferable. Further, from the perspective of effectively securing the contact area between the inner wall surface of the insertion hole 11 and the wire 35, the valley hole diameter Dv preferably satisfies Dv/ϕ<0.98, more preferably satisfies Dv/ϕ<0.97 in a relationship with the outer diameter ϕ of the wire 35.

Not only the sizes and shapes of the lip portions 11b and the lip valley 11c, but also those of the enlarged diameter portions 11a contribute to the suppression of the tear of the constituent material of the seal member 10 when the terminal 20 is inserted into the insertion hole 11. For example, the opening hole diameter Do, which is a maximum value of the inner diameter in the enlarged diameter portions 11a, i.e. the inner diameter of opening parts 11e of the insertion hole 11 in the front and rear surfaces 12, 13, may satisfy Do/W>3.5 with respect to the tab width W of the terminal 20. Since the enlarged diameter portion 11a provided on the end part of the insertion hole 11 has the opening hole diameter Do larger than the tab width W of the terminal 20, even if an angle of the terminal 20 being inserted into the insertion hole 11 is inclined with respect to the insertion axis A, the terminal 20 is easily guided from the enlarged diameter portion 11a to the inside of the insertion hole 11 and inserted into the insertion hole 11 at an angle along the insertion axis A. By setting Do/W>3.5, an effect of guiding straight insertion of the terminal 20 can be enhanced. As a result, it is possible to suppress the application of a large load to the inner wall surface of the insertion hole 11 and the associated tear of the constituent material of the seal member 10, which could occur when the terminal 20 is inserted obliquely to the insertion axis A. From the perspective of further enhancing those effects, Do/W≥3.6 or Do/W≥3.8 is further preferable. An upper limit of the opening hole diameter Do is not particularly determined, but Do/W<5.0 is preferable from the perspective of easily guiding straight insertion of the terminal 20. Note that if the opening part 11e of the insertion hole 11 is chamfered (round shape is given), an enlarged diameter shape of the enlarged diameter portion 11a may be extrapolated and an inner diameter of that extrapolated figure at the position of the opening part 11e may be regarded as the opening hole diameter Do.

Further, an opening angle θ2 of the enlarged diameter portion 11a also affects an angle of guiding the terminal 20 into the insertion hole 11. Here, the opening angle θ2 of the enlarged diameter portion 11a indicates an angle formed by left and right inclined surfaces of the enlarged diameter portion 11a in the longitudinal cross-section of the insertion hole 11. By forming the enlarged diameter portion 11a having a large opening angle θ2 on the end part of the insertion hole 11, the terminal 20 is easily guided into the insertion hole 11 from the enlarged diameter portion 11a and moves into the inside of the insertion hole 11 at an angle along the insertion axis A even if the terminal 20 being inserted into the insertion hole 11 is inclined with respect to the insertion axis A. If θ2>20° is set, the effect of guiding straight insertion of the terminal 20 can be enhanced and it is possible to suppress the application of a large load to the inner wall surface of the insertion hole 11 and the associated tear of the constituent material of the seal member 10, which could occur when the terminal 20 is inserted obliquely to the insertion axis A. If θ2>25° or θ2>28° is set, those effects can be further enhanced. An upper limit of the opening angle θ2 is not particularly determined, but θ2<40° is preferable from the perspective of suppressing the contact of the terminal 20 and the constituent material of the seal member 10 and reducing the formation of scratches.

As described above, the transverse cross-sectional shape at each position of the insertion hole 11 along the insertion axis A is not particularly limited and can be elliptical, circular or the like. However, the transverse cross-sectional shape at each position of the insertion hole 11, particularly the transverse cross-sectional shape at the positions of the top parts 11d of the lip portions 11b, which are the narrowest parts, is preferably perfectly circular rather than being elliptical. If the cross-sectional shape of the insertion hole 11 is circular, the tear of the seal member 10 is less likely to occur when the terminal 20 is inserted into the insertion hole 11 than if the cross-sectional shape of the insertion hole 11 is elliptical. It is thought to be a cause of suppressing the tear that the inner wall surface of the insertion hole 11 is less likely to be dragged by the terminal 20 when the terminal 20 passes in the insertion hole 11 or, even if the inner wall surface is dragged, such a dragged state is easily released if the insertion hole 11 has a circular cross-sectional shape.

(Overall Dimensions of Seal Member)

Although the structure of the insertion hole 11 provided in the seal member 10 has been studied to enhance the waterproofness of the waterproof connector 1 thus far, parameters relating to the overall dimensions of the seal member 10 also affect an improvement in the waterproofness of the waterproof connector 1. Next, the overall dimensions of the seal member 10 are studied.

First, a thickness of an excess material provided outside a region where the insertion holes 11 are provided, i.e. a thickness of a region where the insertion holes 11 are not formed, in the seal member 10 (width in the plate surface of the seal member 10) affects the waterproofness of the waterproof connector 1. The thickness of the excess material can be expressed by a vertical excess length T1 and a horizontal excess length T2. The vertical excess length T1 indicates a thickness of the seal member 10 between an end edge of the opening part 11e of the insertion hole 11 located at an outermost position along a vertical direction of the plate surface of the seal member 10 and an end edge 10a of the seal member 10 located outside that insertion hole 11 along the vertical direction. Further, the horizontal excess length T2 indicates a thickness of the seal member 10 between the end edge of the opening part 11e of the insertion hole 11 located at an outermost position along a horizontal direction of the plate surface of the seal member 10 and an end edge 10b of the seal member 10 located outside that insertion hole 11 along the horizontal direction. Note that, as described above, a plurality of the insertion holes 11 can be arranged in each of the horizontal and vertical directions in the plate surface of the seal member 10, and less insertion holes 11 are arranged in the vertical direction than in the horizontal direction. As in the shown form, only one row of the insertion holes 11 may be arranged in the vertical direction. Further, if an uneven structure is present along a thickness direction of the seal member 10 (direction parallel to directions of arrow directions A in FIG. 1) on the end edges 10a, 10b of the seal member 10, outermost locations of the seal member 10 may be regarded as the positions of the respective end edges 10a, 10b and the respective excess lengths T1, T2 may be specified.

In the seal member 10, as the vertical and horizontal excess lengths T1, T2 increase, i.e. as the excess material becomes thicker, the insertion holes 11 are less likely to be deformed even if a force is applied to the seal member 10 in the vertical or horizontal direction such as when the seal member 10 is accommodated into the housing 40. Then, it is possible to suppress an increase of a load applied to the inner wall surface of the insertion hole 11 when the terminal 20 is inserted and a reduction of close contact of the inner wall surface of the insertion hole 11 with the wire with terminal 30 due to the deformation of the insertion hole 11. As a result, the waterproofness of the waterproof connector 1 is more easily ensured.

Specifically, the vertical and horizontal excess lengths T1, T2 preferably satisfy T1/Dm>1.1 and T2/Dm>1.1 with respect to the minimum hole diameter Dm. Further, the vertical excess length T1 particularly preferably satisfies T1/Dm>2.1 or T1/Dm≥2.3. The horizontal excess length T2 particularly preferably satisfies T2/Dm≥1.2. Note that a particularly preferable lower limit value is set larger for the vertical excess length T1 than for the horizontal excess length T2 because less rows of the insertion holes 11 are arranged in the vertical direction and an influence of a small excess length tends to be largely exhibited via the deformation of the insertion holes 11 if the excess length is small. For the same reason, T1>T2 is preferable. Note that upper limits are not particularly provided for the vertical and horizontal excess lengths T1, T2, but T1/Dm<3.0 and T2/Dm<2.0 are preferable, such as not to excessively enlarge the seal member 10.

As described above, by compressing the seal member 10 when the seal member 10 is accommodated into the housing 40, the intrusion of water from between the seal member 10 and the housing 40 can be suppressed and high waterproofness can be ensured in the waterproof connector 1. At this time, a compression rate of the seal member 10 and a relationship of compression rates in the vertical and horizontal directions also affect the waterproofness of the waterproof connector 1. Here, a dimension along the vertical direction is referred to as a seal vertical dimension L1 and a dimension along the horizontal direction is referred to as a seal horizontal dimension L2 in the seal member 10. Further, out of inner dimensions of a hollow part of the housing 40, particularly inner dimensions at the position of the rear wall surface 42, the inner dimension along the vertical direction of the seal member 10 to be accommodated into the housing 40 is referred to as a housing vertical dimension L′1. Similarly, the inner dimension along the horizontal direction of the seal member 10 is referred to as a housing horizontal dimension L′2. To configure the seal member 10 such that the seal member 10 is accommodated in a compressed state into the housing 40, outer dimensions of the seal member 10 need to be larger than the inner dimensions of the hollow part of the housing 40 in the vertical and horizontal directions. That is, L1>L′1 and L2>L′2 are necessary.

Here, a vertical compression rate R1 and a horizontal compression rate R2 of the seal member 10 are respectively defined as ratios of the outer dimensions of the seal member 10 to the inner dimensions of the hollow part of the housing 40 in the vertical and horizontal directions. That is, R1=L1/L′1 and R2=L2/L′2. In this case, R1>1.03 and R2>1.03 are preferable from the perspective of ensuring high waterproofness.

Further, a relationship of the vertical and horizontal compression rates R1, R2 of the seal member 10 also affects the waterproofness of the waterproof connector 1. If the seal member 10 accommodated into the housing 40 is compressed in a concentrated manner in either one of the vertical and horizontal directions, the insertion holes 11 are deformed in a distorted manner in the vertical and horizontal directions and the cross-sectional shape changes to a shape with a distorted ratio of the vertical and horizontal dimensions. Specifically, in the direction in which the compression rate is increased, the inner dimension of the insertion hole 11 becomes smaller, a large load is applied when the terminal 20 is inserted and a tear easily occurs. On the other hand, in the direction in which the compression rate is reduced, the inner dimension of the insertion hole 11 does not become smaller very much, and close contact between the wire with terminal 30 and the inner wall surface of the insertion hole 11 tends to decrease in a state after the terminal 20 is inserted. To suppress those phenomena, it is preferable to prevent the vertical and horizontal compression rates R1, R2 of the seal member 10 from largely differing from each other. Further, the transverse cross-sectional shape of the insertion hole 11 is preferably perfectly circular rather than being elliptical as described above. As the vertical and horizontal compression rates R1, R2 become closer to each other, the insertion hole 11 having a perfectly circular cross-section is easily compressed while keeping the perfect circular shape. For example, a compression rate ratio R2/R1 of the horizontal compression rate R2 to the vertical compression rate R1 may be set within a range of 0.9<R2/R2<1.1. 0.95≤R2/R1≤1.05 or 0.99≤R2/R1≤1.01 are further preferable.

### EXAMPLES

Examples are described below. Here, the influence of the structure and overall dimensions of insertion holes in a seal member on the waterproofness of a waterproof connector was studied. The study was conducted, combining an analysis using computer aided engineering (CAE) and an experiment on actually fabricated waterproof connectors. Note that the present disclosure is not limited by these Examples.

[Test Method]

### [1] CAE Analysis

A force and a deformation amount generated when a terminal is inserted into a seal member accommodated in a connector housing were estimated using the CAE analysis.

Models of connectors A1 to A3 and B1 to B3 structured similar to the one shown in FIGS. 1 to 3 were prepared as analysis models. Those connectors differ from each other in dimensions of each part of a constituent member. The dimensions of each part are as shown in Table 1. Each dimension of Table 1 is a value in a state where the seal member is not accommodated in the connector housing and the terminals are not inserted in the insertion holes of the seal member.

Silicone rubber having a Shore A hardness of 20, 100% modulus of 0.3 MPa and 300% modulus of 0.6 MPa was used as a material constituting the seal member. The insertion holes are arranged in one row in a vertical direction and eight rows in a horizontal direction in the seal member.

With the seal member accommodated in the connector housing, wires having a diameter ϕ of 17.8 mm were passed through the insertion holes other than the fourth insertion hole from the left when viewed from a rear surface. Then, distributions of deformation and stress of an inner wall surface were evaluated by simulation while the terminal is inserted into the fourth insertion hole from the left from the rear surface to a front surface. A structural analysis by a finite element method was used in the simulation (analysis software: LS-DYNA).

In the analysis, a terminal insertion force and a maximum stress and a maximum deformation amount in the insertion hole were also estimated. The terminal insertion force was evaluated as a maximum value of a force required while the terminal is passing through the insertion hole. The maximum stress and the maximum deformation amount were respectively evaluated as maximum values of a stress and a deformation amount generated in each part of the silicone rubber material surrounding the insertion hole while the terminal is passing through the insertion hole. The maximum deformation amount is expressed as an elongation percentage of the constituent material on the basis of a state before the insertion of the terminal.

[2] Evaluation by Experiment

Further, waterproof connectors were actually fabricated and evaluation was made on the presence or absence of a tear in a seal member during the insertion of terminals and waterproofness. Connectors A1 to A3, B1 to B3 similar to those used as the models of the CAE analysis above were actually manufactured.

Evaluation on Tear

In each connector, a terminal part of a wire with terminal is inserted into and passed through each insertion hole successively from the left viewed from a rear surface side with a seal member accommodated in a housing. Thereafter, each wire with terminal is pulled out from the insertion hole and the seal member was removed from the connector housing. Inner wall surfaces of the insertion holes were visually observed and the presence or absence of the tear was evaluated. If the inner wall surface of the insertion hole was torn (crack in a constituent material of the seal member), if a lip portion was pierced through (hole vertically penetrating through the lip portion was formed), or if there was a defect in the inner wall surface of the insertion hole (constituent material of the seal member is missing), the presence of the tear (B) was evaluated. On the other hand, if none of those phenomena was found in the inner wall surfaces of the insertion holes, the absence of the tear (A) was evaluated. Particularly, if neither the tear nor even slight scratches were found in the inner wall surfaces of the insertion holes, the absence of scratches (A+) was evaluated.

Evaluation on Waterproofness

A leak test was conducted to evaluate waterproofness for each connector in a state where the wire with terminal is inserted in each insertion hole of the seal member accommodated in the connector housing and a wire part is arranged in the insertion hole. At this time, each connector was mounted on one end of a tube to form a test sample. Subsequently, a part of the connector of the test sample was immersed in water and air was introduced from the other end of the tube at a pressure of 50 kPa for 30 minutes. Whether or not any air bubble was generated from a part between the seal member and each wire with terminal in the waterproof connector immersed in water was visually observed while the air was introduced. In air bubbles were generated, it was determined that there was a leakage in the connector and waterproofness was low (B). On the other hand, if no air bubble was generated, it was determined that there was no leakage in the connector and waterproofness was high (A). Note that it was separately confirmed that no air bubble was generated from between the housing and the seal member and between the tube and the waterproof connector.

Evaluation on Waterproofness after High-Temperature Withstanding

Waterproofness after high-temperature withstanding was evaluated for the connectors A3, and B1 to B3. Each connector was left in an environment of 125° C. for 1000 hours with the wire part of each wire with terminal arranged in the insertion hole of the seal member accommodated in the housing. After the connector was returned to room temperature, the leak test was conducted in the same manner as above. However, two air pressures of 30 kPa and 50 kPa were applied. In the leak test, the waterproofness after high-temperature withstanding was determined to be low (B) if there was a leakage in the connector even at the air pressure of 30 kPa. On the other hand, the waterproofness after high-temperature withstanding was determined to be high (A) if there was no leakage at the air pressure of 30 kPa. Further, the waterproofness after high-temperature withstanding was determined to be particularly high (A+) if there was no leakage even at the air pressure of 50 kPa.

[Test Results]

The configurations and evaluation results of the respective parts of the connectors A1 to A3, B1 to B3 are summarized in Table 1 below. Note that if “elliptical” is written for the hole shape, the cross-sectional shape is elliptical (length ratio of a minor axis to a major axis is 1:1.23) only near the opening parts and the cross-sectional shape of the inside of the insertion hole is perfectly circular. Further, if the hole shape is “perfectly circular”, the opening parts of the insertion hole are not chamfered and an inner diameter at the positions of the opening parts of the insertion hole is directly employed as the opening hole diameter Do. On the other hand, if the hole shape is “elliptical”, the opening parts of the insertion hole are chamfered and an inner diameter at the positions of the opening parts of extrapolated figures of the shapes of enlarged diameter portions was employed as the opening hole diameter Do.

| Connector Type | | A1 | A2 | A3 | B1 | B2 | B3 |
|---|---|---|---|---|---|---|---|
| Male | Tab Width (W) [mm] | 0.64 | 0.64 | 0.64 | 0.64 | 0.64 | 0.64 |
| Terminals | | | | | | | |
| Wires | Diameter ϕ [mm] | 1.78 | 1.78 | 1.78 | 1.78 | 1.78 | 1.78 |
| Structure of | Minimum Hole Diameter Dm [mm] | 0.70 | 0.70 | 0.90 | 0.75 | 0.75 | 0.75 |
| Insertion | Dm/W | 1.1 | 1.1 | 1.4 | 1.2 | 1.2 | 1.2 |
| Holes | Valley Hole Diameter Dv [mm] | 1.50 | 1.75 | 1.50 | 1.68 | 1.68 | 1.68 |
| | Dv/W | 2.3 | 2.7 | 2.3 | 2.6 | 2.6 | 2.6 |
| | Opening Hole Diameter Do [mm] | — | — | — | 2.4 | 2.4 | 2.4 |
| | Do/W | — | — | — | 3.8 | 3.8 | 3.8 |
| | Lip Angle θ1 [°] | 95.1 | 32.9 | 110.7 | 55.5 | 55.5 | 55.5 |
| | Opening Angle θ2 [°] | 28 | 20 | 28 | 28 | 28 | 28 |
| | Hole shape | Elliptical | Elliptical | Elliptical | Perfectly | Perfectly | Perfectly |
| | | | | | Circular | Circular | Circular |
| Overall | Vertical Dimension L1 [mm] | 6.0 | 6.0 | 6.0 | 5.8 | 6.9 | 6.9 |
| Dimensions | Horizontal Dimension L2 [mm] | 22.8 | 22.8 | 22.8 | 23.0 | 23.0 | 23.0 |
| of Seal | Thickness [mm] | 4.5 | 4.5 | 4.5 | 4.3 | 4.3 | 4.3 |
| Member | Vertical Excess Length T1 [mm] | 1.48 | 1.48 | 1.48 | 1.70 | 2.30 | 2.30 |
| | T1/Dm | 2.1 | 2.1 | 1.6 | 2.3 | 3.1 | 3.1 |
| | Horizontal Excess Length T2 [mm] | 1.06 | 1.06 | 1.06 | 0.92 | 0.92 | 0.92 |
| | T2/Dm | 1.5 | 1.5 | 1.2 | 1.2 | 1.2 | 1.2 |
| Housing | Vertical Dimension L′1 [mm] | 5.4 | 5.4 | 5.4 | 5.4 | 6.7 | 6.6 |
| Dimensions | Horizontal Dimension L′2 [mm] | 22.2 | 22.2 | 22.2 | 22.2 | 22.2 | 22.2 |
| | Thickness [mm] | 4.9 | 4.9 | 4.9 | 4.9 | 4.9 | 4.9 |
| Compression | Vertical Compression Rate R1 | 1.11 | 1.11 | 1.11 | 1.07 | 1.03 | 1.05 |
| of Seal | Horizontal Compression Rate R2 | 1.03 | 1.03 | 1.03 | 1.04 | 1.04 | 1.04 |
| Member | Compression Rate Ratio R2/R1 | 0.92 | 0.92 | 0.92 | 0.96 | 1.01 | 0.99 |
| Evaluation | Terminal Insertion Force [N] | 6.81 | 5.94 | 5.55 | 5.07 | 3.49 | 3.64 |
| Results | Maximum Stress [MPa] | 6.46 | 6.20 | 2.32 | 4.35 | 4.40 | 4.46 |
| | Maximum Deformation Amount [%] | 430 | 340 | 310 | 350 | 350 | 350 |
| | Presence or Absence of Tear | B | B | A+ | A | A+ | A+ |
| | Waterproofness | B | B | A | A | A | A |
| | Waterproofness after High- | — | — | B | A+ | A | A+ |
| | Temp Withstanding | | | | | | |

According to Table 1, the terminal insertion force and the maximum stress in the insertion hole are notably smaller in the connector A3 and B1 to B3 in which the minimum hole diameter Dm of the insertion holes satisfies 1.1<Dm/W with respect to the tab width W of the terminals than in the connectors A1, A2 in which Dm/W=1.1. The wall surfaces of the insertion holes were torn (presence or absence of tear: B) during the insertion of the terminals and waterproofness was low (waterproofness: B) in the connectors A1, A2, whereas there was no tear (presence or absence of tear: A or A+) during the insertion of the terminals and high waterproofness was obtained (waterproofness: A) in the connectors A3 and B1 to B3. From these, it can be said that, by setting Dm/W>1.1, a load applied to the inner wall surface of the insertion hole according to the insertion of the terminal is suppressed to be small and, as a result, the tear in the inner wall surface of the insertion hole can be suppressed and high waterproofness can be maintained.

In the connector A3 in which Dm/W=1.4, no tear was formed in the inner wall surfaces of the insertion holes (presence or absence of tear: A+) and high waterproofness was obtained (waterproofness: A) in a state before high-temperature withstanding since the minimum hole diameter Dm is large, but waterproofness was low after high-temperature withstanding (waterproofness after high-temperature withstanding: B). A reduction in waterproofness due to high-temperature withstanding is thought to be because a close contact state could not be maintained between the insertion holes and the wires when the constituent material of the seal member was thermally affected after high-temperature withstanding since close contact between the inner wall surfaces of the insertion holes and the wires was not sufficiently high. On the other hand, in the connectors B1 to B3 in which Dm/W<1.4, high waterproofness was maintained even after high-temperature withstanding (waterproofness after high-temperature withstanding: A or A+). From this, it can be said that high close contact capable of maintaining high waterproofness even after high-temperature withstanding can be obtained between the inner wall surface of the insertion hole and each wire with terminal by setting Dm/W<1.4. From the above, it can be understood that, by setting the minimum hole diameter Dm in the range of 1.1<Dm/W<1.4, high waterproofness can be achieved in the waterproof connector as a result of both the suppression of the tear in the inner wall surfaces of the insertion holes and the ensuring of close contact between the inner wall surface of the insertion hole and each wire with terminal.

The connectors B1 to B3 differed from each other in the vertical dimension L′1 of the housing and, accordingly, the vertical compression rates R1 and the compression rate ratios R2/R1 of the seal members also differed from each other. Further, the connector B1 differed from the connectors B2, B3 also in the vertical excess length T1. Neither the tear nor slight scratches were formed by the insertion of the terminal (presence or absence of tear: A+) in the connectors B2, B3 in which the compression rate ratio R2/R1 of the seal member was close to 1.00 (R1=R2) and the vertical excess length T1 was large, out of these three types of connectors. This result is thought to be because the insertion hole formed into a perfect circular shape was not compressed in a distorted manner and a load applied to the inner wall surface was highly uniformly distributed to each part of the inner wall surface. Further, in the connectors B1, B3, waterproofness after high-temperature withstanding was particularly high (A+). This result is thought to be because the vertical compression rate R1 was larger in the connectors B1, B3 than in the connector B2 and close contact of the inner wall surface of the insertion hole with the wire with terminal was further improved by the compression of the seal member. The connectors B1 to B3 satisfied the preferable ranges listed above for each of the valley hole diameter Dv, the opening hole diameter Do, the lip angle θ1, the opening angle θ2, the vertical excess length T1 and the horizontal excess length T2.

Although the embodiment of the present disclosure has been described in detail above, the present disclosure is not limited to the above embodiment at all and various changes can be made without departing from the gist of the present disclosure.

What is claimed is:

1. A waterproof connector, comprising:
a seal including an insertion hole as a through hole; and
a connector terminal configured as a male terminal including a tab to be fit and connected to a mating terminal, wherein:
the connector terminal is inserted into the insertion hole of the seal along an insertion axis, and
a width of the tab of the connector terminal has a tab width W and an inner diameter of a narrowest part having a smallest inner diameter of a transverse cross-section orthogonal to the insertion axis in the insertion hole has a minimum hole diameter Dm, the minimum hole diameter Dm satisfies 1.1<Dm/W<1.4 in a state where the connector terminal is not inserted in the insertion hole.

2. The waterproof connector of claim 1, wherein:
a lip shaped to be convex inwardly of the insertion hole in a longitudinal cross-section parallel to the insertion axis is formed on an inner wall surface of the insertion hole and a top of the lip serves as the narrowest part, and
an angle formed by two tangents to slopes on both sides of the top of the lip in the longitudinal cross-section has a lip angle θ1, the lip angle θ1 is smaller than 90° in the state where the connector terminal is not inserted in the insertion hole.

3. The waterproof connector of claim 1, wherein:
the insertion hole of the seal includes a plurality of insertion holes and the plurality of insertion holes are arranged in a plurality of rows along a horizontal direction and in fewer rows in a vertical direction intersecting the horizontal direction than in the horizontal direction in a surface of the seal, and
a thickness of the seal between an end edge of an opening part of an outermost insertion hole of the plurality of insertion holes along the vertical direction and an end edge of the seal located outside the outermost insertion hole along the vertical direction has a vertical excess length T1, the vertical excess length T1 satisfies T1/Dm>2.1 in the state where the connector terminal is not inserted in the insertion hole.

4. The waterproof connector of claim 1, wherein:
the insertion hole of the seal includes a plurality of insertion holes and the plurality of insertion holes are arranged in a plurality of rows along a horizontal direction and in fewer rows in a vertical direction intersecting the horizontal direction than in the horizontal direction in a surface of the seal, and
a thickness of the seal between an end edge of an opening part of an outermost insertion hole of the plurality of insertion holes along the horizontal direction and an end edge of the seal located outside the outermost insertion hole along the horizontal direction has a horizontal excess length T2, the horizontal excess length T2 satisfies T2/Dm>1.1 in the state where the connector terminal is not inserted in the insertion hole.

5. The waterproof connector of claim 1, further comprising:
a connector housing including a hollow part and the seal is accommodated in a compressed state in the hollow part of the connector housing, wherein:
the insertion hole of the seal includes a plurality of insertion holes and the plurality of insertion holes are arranged in a plurality of rows along a horizontal direction and in fewer rows in a vertical direction intersecting the horizontal direction than in the horizontal direction in a surface of the seal, and
a dimension along the vertical direction is a seal vertical dimension L1 and a dimension along the horizontal direction is a seal horizontal dimension L2 in the seal in a state not accommodated in the connector housing, an inner dimension of the hollow part along the vertical direction of the seal has a housing vertical dimension L′ 1 and an inner dimension of the hollow part along the horizontal direction of the seal has a housing horizontal dimension L′2 in the hollow part of the connector housing, and a vertical compression rate R1 and a horizontal compression rate R2 of the seal are L1/L′ 1 and L2/L′2, the vertical and horizontal compression rates R1, R2 satisfy a relationship of 0.9<R2/R1<1.1.

6. The waterproof connector of claim 1, wherein:
at least two lips shaped to be convex inwardly of the insertion hole in a longitudinal cross-section parallel to the insertion axis are formed along the insertion axis on an inner wall surface of the insertion hole, and
an inner diameter of a lip valley having a largest inner diameter of the transverse cross-section orthogonal to the insertion axis between two lips adjacent along the insertion axis has a valley hole diameter Dv, the valley hole diameter Dv satisfies Dv/W>2.3 in the state where the connector terminal is not inserted in the insertion hole.

7. The waterproof connector of claim 6, wherein the valley hole diameter Dv satisfies Dv/W<2.7 in the state where the connector terminal is not inserted in the insertion hole.

8. The waterproof connector of claim 1, wherein:
the insertion hole includes an enlarged diameter enlarged in diameter from an inner side toward an outer side along the insertion axis on an end along the insertion axis and,
a maximum value of an inner diameter of the enlarged diameter has an opening hole diameter Do, the opening hole diameter satisfies Do/W>3.5 in the state where the connector terminal is not inserted in the insertion hole.

9. The waterproof connector of claim 1, wherein the seal contains silicone rubber.

10. The waterproof connector of claim 1, wherein a hardness of the seal is 10 or more and 30 or less in Shore A hardness.

11. The waterproof connector of claim 1, wherein:
the connector terminal is connected to an end of a wire, and
an inner wall surface of the insertion hole of the seal is in contact with a surface of the wire.
